(19) United States
(12) Patent Application Publication
(10) Pub. No.: US 2003/0101082 A1
(43) Pub. Date: May 29, 2003

(54) Systems and methods for managing customer-related communications

(75) Inventors: James L. Volpe, Raleigh, NC (US); Mark Dabkowski, Raleigh, NC (US); Barry Johnson, Raleigh, NC (US); Kristin Simora, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC

(21) Appl. No.: 09/997,571

(22) Filed: Nov. 29, 2001

(51) Int. Cl. G06F 17/60

(52) U.S. Cl. 705/8

(57) ABSTRACT

Systems and techniques are described for the management of a business organization's customer-related communications. One system is described that includes a central server computer, at least one originator terminal connected to the central server computer, at least one owner terminal connected to the central server terminal, and a database accessible by the central server computer. The originator terminal receives from an originator a submission containing customer-related information and transmits the submission to the central server computer. The submission includes a designation of a category of the submission, customer information, and an identified business issue. Based upon the submitted information, the system automatically assigns an owner to the submission, stores the submission in the database, and informs the owner of the assignment. The owner then develops a response to the submission and documents the response by using the owner terminal to access and updating the submission. The updated submission is then stored in the database.

### BACKGROUND OF THE INVENTION

1. Field of the Invention

The present invention relates generally to improvements to systems and methods for managing sales and marketing information, and more particularly to advantageous aspects of systems and methods for customer-related communications.

2. Description of the Prior Art

The management of customer-related communications by a business organization is often handled in a haphazard fashion. A business organization may employ a plurality of processes that are not integrated into a coherent system. Thus, it may be difficult for a business organization to monitor customer-related communications to ensure that the communications are being handled in an efficient manner, and to measure and improve employee performance.

### SUMMARY OF THE INVENTION

Various aspects of the present invention provide systems and methods for the management of customer-related communications. One aspect of the invention provides a system for managing a business organization's customer-related communications, comprising a central server computer, at least one originator terminal connected to the central server computer, at least one owner terminal connected to the central server terminal, and a database accessible by the central server computer. The originator terminal receives from an originator a submission containing customer-related information and transmits the submission to the central server computer. The submission includes a designation of a category of the submission, customer information, and an identified business issue. Based upon the submitted information, the system automatically assigns an owner to the submission, stores the submission in the database, and informs the owner of the assignment. The owner then develops a response to the submission and documents the response by using the owner terminal to access and updating the submission. The updated submission is then stored in the database.

Additional features and advantages of the present invention will become apparent by reference to the following detailed description and accompanying drawings.

### BRIEF DESCRIPTION OF THE DRAWINGS

FIG. 1 shows a flow diagram that maps the flow of customer-related communications according to an aspect of the invention.

FIG. 2 shows a diagram of a system for managing customer-related communications according to an aspect of the invention.

FIG. 3 shows a flowchart of a method for managing customer-related communications according to an aspect of the invention.

FIG. 4 shows a table setting forth categories of submissions according to an aspect of the invention.

FIGS. 5A and 5B show a process map of a method for managing customer-related communications.

FIG. 6 shows a screenshot of a main menu screen according to an aspect of the invention.

FIGS. 7A, 7B and 7C show an add submission screen according to an aspect of the invention.

FIGS. 8A and 8B show an update submission screen used to track response-required submissions according to an aspect of the invention.

FIGS. 9A-D show a series of charts that are used to measure performance according to an aspect of the invention.

FIG. 10 shows a screenshot of a response required search screen according to an aspect of the invention.

FIG. 11 shows a screenshot of a response required search results screen according to an aspect of the invention.

FIG. 12 shows a screenshot of an external customer submission screen according to an aspect of the invention.

FIGS. 13A and 13B show a screenshot of a for your information (FYI) response quality monitoring screen according to an aspect of the invention.

FIG. 14 shows an FYI search results screen according to an aspect of the invention.

### DETAILED DESCRIPTION

As used herein, the terms “Voice of the Customer” and “VOC” refer collectively to systems and methods for managing customer-related communications according to aspects of the invention.

As used herein, the term “system” refers to hardware, software, or any combination thereof. The systems described herein may be implemented on standard, general-purpose computers or utilizing specialized devices.

As used herein, the term “VOC originator” refers to a salesperson or other authorized person, other than a customer, who makes a VOC submission in accordance with aspects of the invention.

As used herein, the term “VOC submission” refers to a submission of information by a VOC originator or customer into the Voice of the Customer system. As described below, a VOC submission is categorized and stored in a database herein referred to as a “VOC database.” VOC submissions may include, for example, a request from a customer, customer or marketing information acquired by a salesperson, an expression of customer dissatisfaction, or other customer-related information.

As used herein, the term “VOC owner” refers to a person designated by a business organization to be accountable for responding to a VOC submission.

As used herein, the term “central server computer” refers to a computer system that administers a network. The central server computer may include more than one computing unit, and may also include, as desired, peripheral units for inputting, outputting, and storing data.

As used herein, the term “network” includes local networks, as well as networks including Internet connections.

As used herein, the term “terminal” includes stand-alone personal computers (PCs), workstations, personal digital assistants (PDAs), or any other device connected into a network for receiving inputs from, and providing outputs to, VOC originators, customers, VOC owners, and other persons in accordance with aspects of the invention. These terminals may be dedicated to the Voice of the Customer system, or may be multipurpose.

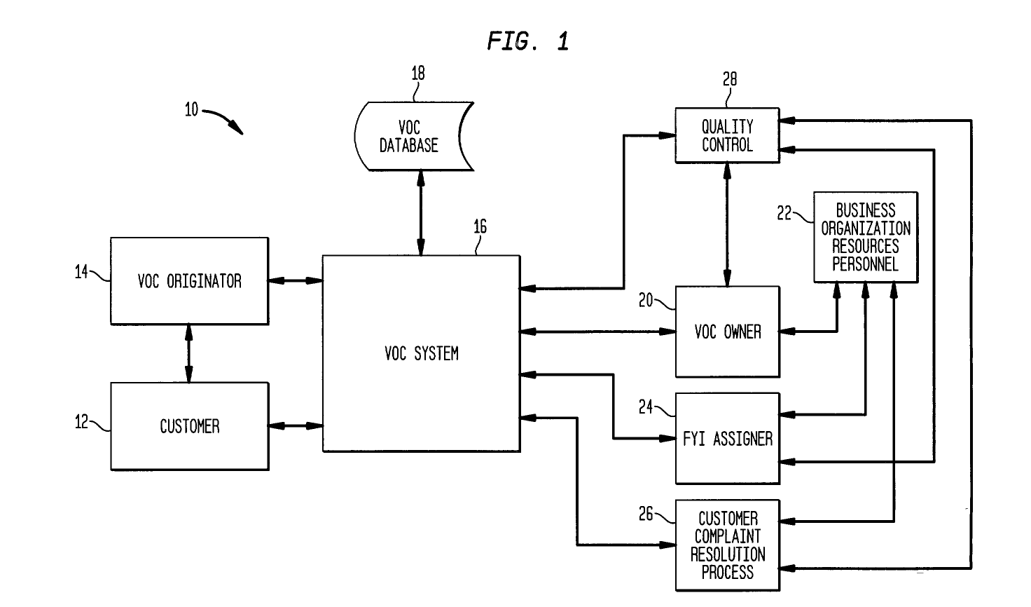

FIG. 1 shows a diagram showing a map 10 of customer-related communications according to an aspect of the invention. A customer 12 may communicate information to a VOC originator 14, who will typically be a salesperson. The communication may be, for example, a request for a decision to be made by the business organization. If the originator 14 is authorized and able to handle the matter without assistance, the originator 14 resolves the matter locally and communicates a response directly back to the customer 12.

However, if the originator 14 needs to interact with personnel within the business organization to handle the request from the customer 12, the originator 14 makes a submission into the VOC system 16, and the submission is stored in a VOC database 18. As described below, as part of the VOC submission, the originator 14 identifies the customer and a business issue. Based upon the identified customer and business issue, the VOC system automatically assigns the VOC submission to a VOC owner 20. After the VOC owner 20 has received the VOC submission, the VOC owner 20 develops a response. In developing the response, the VOC owner 20 may draw upon business organization resources 22, including other personnel, computer resources, files, libraries, and the like. After the VOC owner 20 has prepared a response, the response is transmitted through the VOC system to the originator 14 or directly to the customer 12. The response is documented by updating the VOC submission stored in the VOC database 18.

The VOC originator 14 may also make a submission into the VOC system that is informational in nature, that is, an FYI submission. As described below, an FYI submission is transmitted to a designated FYI assigner 24. The FYI assigner 24 makes sure that the submitted information is distributed to suitable persons within the business organization.

The VOC originator 14 may also submit a customer complaint into the VOC system. As described below, the VOC system routes a customer complaint into a customer complaint resolution process 26.

According to a further aspect of the invention, the customer 12 may make a direct submission into the VOC system 16. The customer's VOC submission is then forwarded to an appropriate VOC owner. The VOC owner's response to the customer 12 is documented by updating the customer's VOC submission stored in the VOC database 18.

The VOC system 16 is also accessible by the business organization's quality control function 28. As described below, an aspect of the invention allows management to review VOC submissions and to track responses made to VOC submissions. In performing its monitoring function, management may deal directly with a VOC owner 20, an FYI assigner 24, or the customer complaint resolution process 26.

Thus, it will be seen that the VOC system allows customer-related communications to be handled in an orderly fashion, with submissions and responses documented and stored in a VOC database.

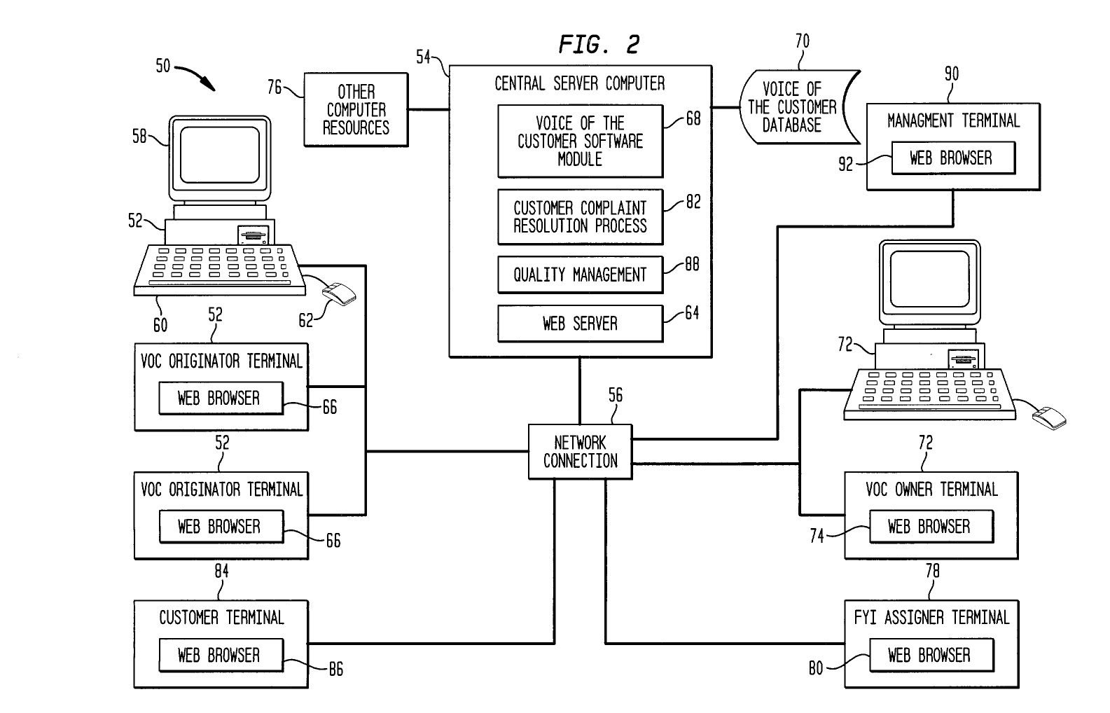

FIG. 2 shows a diagram of a system 50 for managing customer-related communications according to an aspect of the invention. As shown in FIG. 2, the system 50 includes a network of VOC originator terminals 52 administered by a central server computer 54. As shown in FIG. 2, the VOC originator terminals 52 are connected to the central server computer 54 using a network connection 56, which may suitably be an Internet connection or a connection through a local network.

Each VOC originator terminal 52 includes suitable devices for receiving inputs from, and providing outputs to, a salesperson, or other VOC originator. These devices may include a monitor 58, a keyboard 60, a mouse 62, and the like. Other input and output devices may also be used without departing from the spirit of the invention. It is contemplated that a VOC originator terminal 52 may be operated by a salesperson, or other VOC originator, at a remote location in the field. However, it would also be possible for a salesperson, or other VOC originator, to use a local terminal without departing from the spirit of the invention.

The central server computer 54 includes suitable web server software 64 that is used to generate web pages which are sent to the VOC originator terminals 52 for display to salespeople. Each VOC originator terminal 52 includes a suitable web browser 66, such as Microsoft Internet Explorer™ or Netscape Navigator™ for viewing the web pages sent by the central server computer 54.

The central server computer 54 further includes a Voice of the Customer (VOC) software module 68. As described below, the VOC software module 54 is used by the system to manage customer-related communications. The VOC software module 68 and the web server software 64 generate web pages that are transmitted to the originator terminals 52. The web pages are designed to facilitate the tasks of making a VOC submission and managing the VOC submission activity. The gathered data is then stored in a VOC database 70 accessible by the central server computer 54.

As further described below, a VOC submission may fall into one of a number of different categories. If a submission is a response-required submission, the VOC identifies a customer and a business issue. Based upon the identified customer and issue, the central server computer 54 automatically assigns a VOC owner to the submission and notifies the VOC owner of the assignment. As shown in FIG. 2, VOC owners are connected into the system 50 through a network of VOC owner terminals 72. Each VOC owner terminal 72 runs a suitable web browser 74.

When a VOC owner is assigned to a VOC submission, the VOC owner is informed of the assignment using e-mail or other suitable means of communication. If e-mail is used, it can be sent directly to the assigned VOC owner at the VOC owner terminal 72. The VOC owner has access, using a VOC owner terminal 72, to data stored in the VOC database 70, as well as data contained in other databases and computer resources 76 accessible by the central server computer 54. The VOC owner may use a VOC owner terminal 72 to communicate with the originator who made the VOC submission, as well as with other personnel at the business organization. In addition, the VOC owner's response is stored in the VOC database 70.

The VOC submission may be categorized as an FYI submission. As described below, an FYI submission is informational in nature and does not require an immediate response to a customer. In an FYI submission, the originator identifies a customer and a business issue. Based upon the identified customer and issue, the system automatically designates an FYI assigner and informs the FYI assigner of the designation. The FYI assigner documents actions taken pursuant to the submission by using an FYI assigner terminal 78 running a suitable web browser 80 to access and update the submission. The updated submission is then stored in the VOC database 70.

The VOC submission may also be categorized as a customer complaint. In this case, the VOC submission is routed to a customer complaint resolution process 82. The results of the customer complaint resolution process 82 may be stored in the VOC database 70.

The system 50 shown in FIG. 2 further includes at least one customer terminal 84 running a suitable web browser 86 for receiving VOC submissions directly from a customer. These VOC submissions are automatically referred to a VOC owner.

Also, the VOC system includes a quality management component 88. The quality management system may already be existence in the business organization, or may be developed specifically for use with the VOC system. As described below, the quality management component 88 is used to generate reports based upon data contained in the VOC database 70. Management accesses the quality management component 88 and other aspects of the VOC system through a management terminal 90 running a suitable web browser 92.

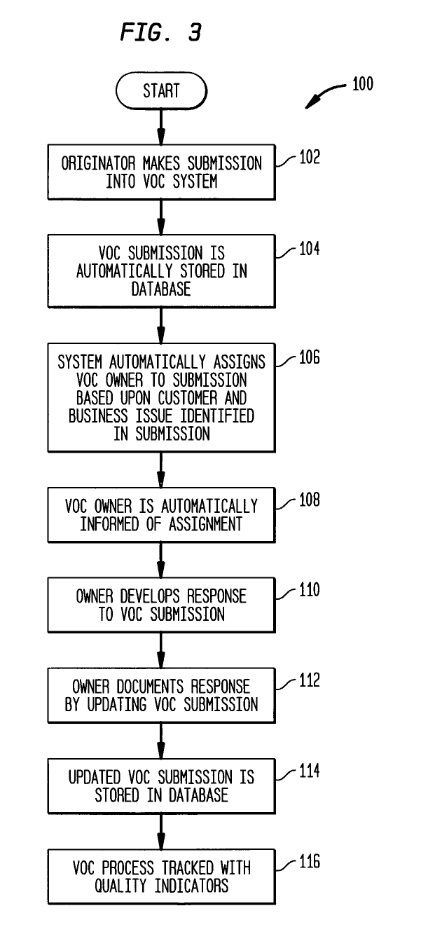

FIG. 3 shows a flowchart illustrating a method 100 for managing customer-related communications according to an aspect of the invention. In step 102, a salesperson or other VOC originator uses a VOC originator terminal to enter a submission into the Voice of the Customer system. As described below, the submission may include, for example, a request for a response on behalf of a customer, a general communication of information received from a customer, or a customer complaint. As further described below, an aspect of the invention includes a website having a web page that is designed to receive a VOC submission at a VOC originator terminal. In step 104, the VOC submission is automatically stored in a database. In step 106, a VOC owner is assigned to the VOC submission based upon the customer and business issue identified in the submission, and in step 108 the VOC owner is informed of the assignment using e-mail or other suitable form of communication. According to an aspect of the invention, the e-mail informing the VOC owner of the assignment includes a link to the VOC submission in the database.

In step 110, the VOC owner reviews the VOC submission in the database and develops a response. In step 112, the VOC owner documents the response by accessing and updating the submission. In step 114, the updated submission is stored in the database. In step 116, the VOC process is tracked using quality indicators. As described below, the VOC system facilitates the tracking of VOC submissions from initial submission by the originator through the development of a response to the submission by a VOC owner. VOC submissions may be monitored for timing and content.

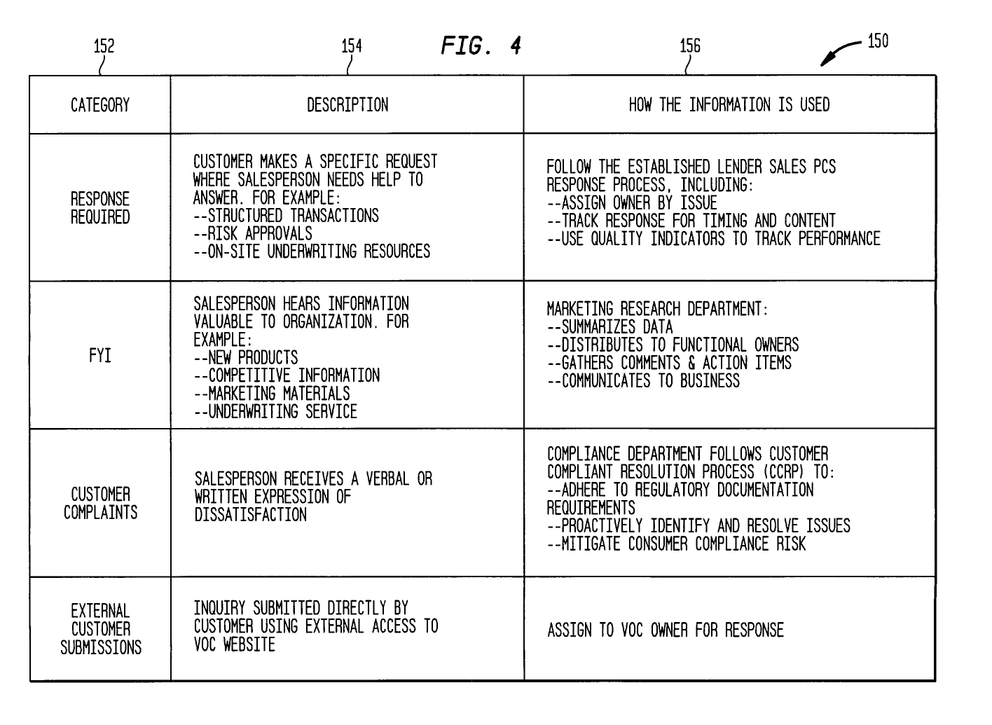

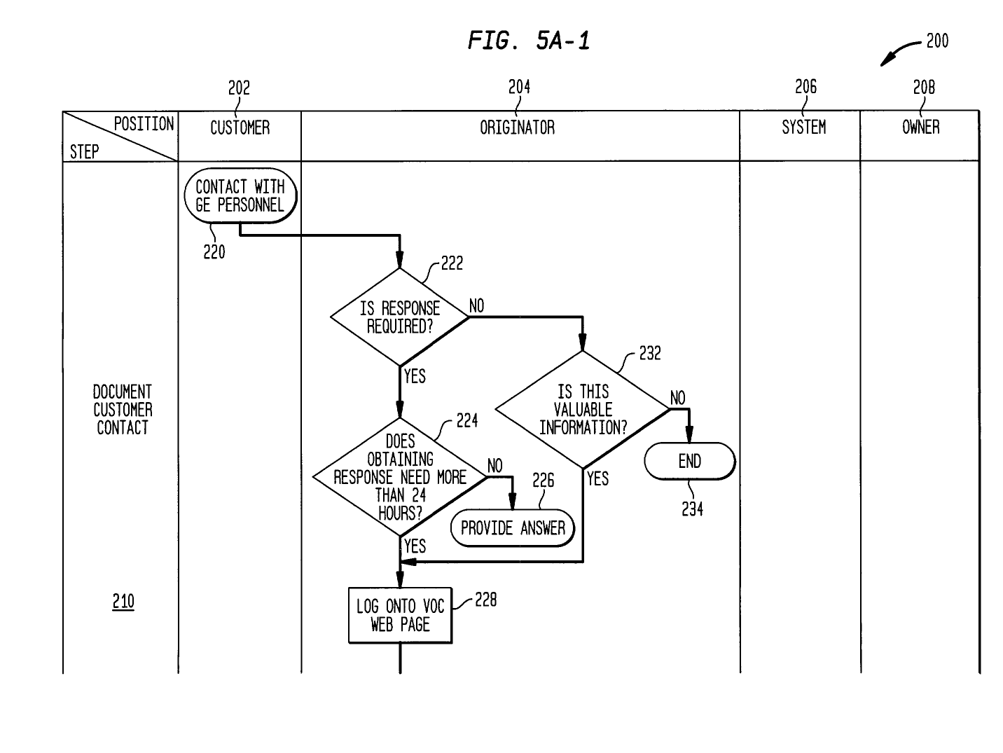

FIG. 4 shows a table 150 illustrating the types of VOC submissions that can be made at a VOC originator terminal. The first column 152 of the table 150 lists submission categories. The second column 154 provides a description of each of the categories. The third column 156 provides a description of how the information from the VOC submission is used.

As shown in FIG. 4, there are four basic categories of VOC submissions: response required (RR), for your information (FYI), customer complaints, and external customer submissions. The first three categories of submissions are made by salespeople or other VOC originators. The fourth category of submissions includes submissions made by customers who access the VOC website externally.

The first category of VOC submission is a response required (RR) submission. An RR submission is a VOC submission in which the salesperson requires a response from a VOC owner. A salesperson would make an RR submission, for example, where a salesperson is structuring a transaction, is seeking risk approval, or requires access to onsite underwriting resources.

As described below, the RR submission includes an assignment of the submission to a VOC owner, based upon the business issue that is raised by the submission. When a VOC owner is assigned to an RR submission, the VOC owner follows an established response process. If the business organization has an already existing process control system (PCS), the response process may be monitored by the PCS, in addition to being documented by the VOC system.

Where a salesperson has information that is valuable to a business organization, but which does not require an immediate response, the salesperson makes an FYI submission. An FYI submission would be made, for example, where a salesperson has received information relating to new products, information relating to competitors, marketing materials, or other information generally relating to underwriting services. FYI submissions are referred to a designated assigner in the business organization's marketing research department. The assigner analyzes and summarizes the submitted data and distributes it to functional owners within the business organization. In addition, comments and action items are gathered, and communicated to appropriate persons in the organization.

A customer complaint submission is made when a salesperson or other VOC originator has received a verbal or written expression of dissatisfaction from a customer. A business organization may have an already established customer complaint resolution process (CCRP). According to an aspect of the invention, when a salesperson receives a customer complaint, the salesperson accesses the CCRP through the VOC system.

According to an aspect of the invention, CC submissions are referred a compliance department within the business organization, where the CCRP is followed, including adherence to regulatory documentation requirements. The compliance department also engages in a proactive identification and resolution of issues. In addition, the compliance department strives to mitigate consumer compliance risk.

As described below, a customer may access the VOC system externally to make a submission directly into the VOC system. A direct customer submission is referred to a VOC owner for handling.

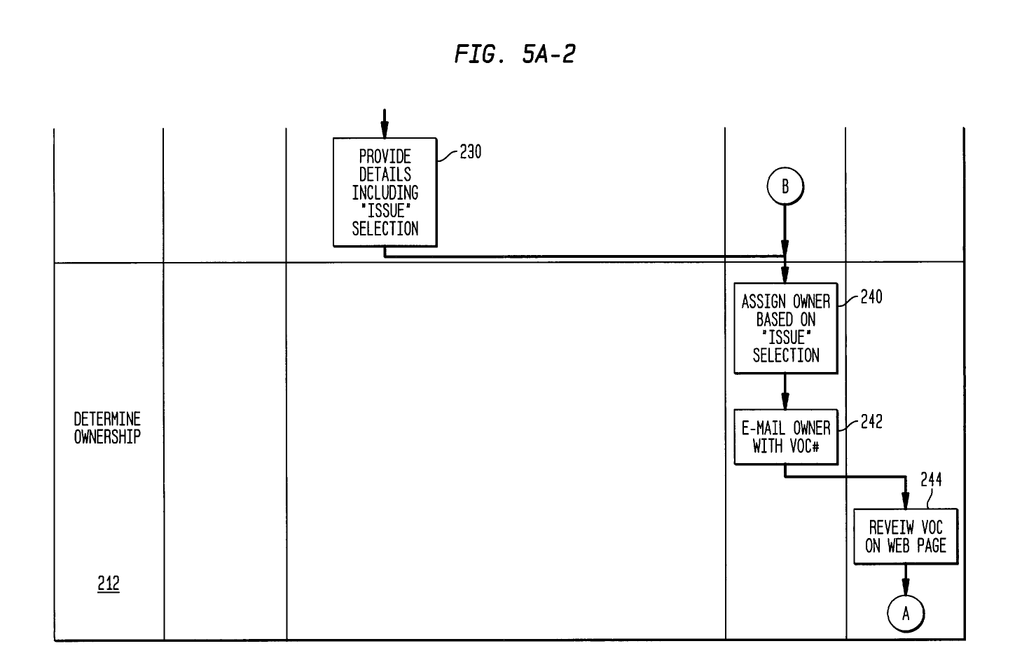

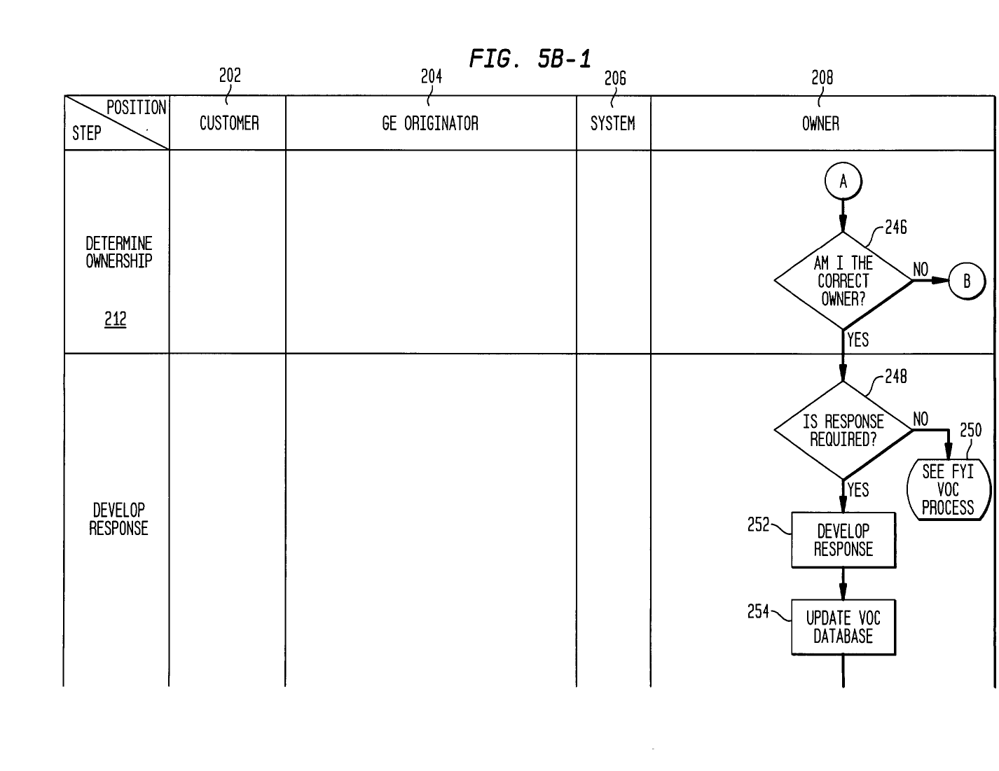

FIGS. 5A and 5B show a process map 200 illustrating the VOC process in further detail. As shown in FIGS. 5A and 5B, the VOC system includes the participation of four entities: a customer 202, a VOC originator 204, the VOC system 206, and a VOC owner 208. As further shown in FIGS. 5A and 5B, the VOC process includes four phases: documentation of a customer contact in the form of a VOC submission 210, determination of the ownership of the VOC submission 212, development of a response by the VOC owner 214, and the provision of a response by the VOC owner 216.

The first phase 210 is the documentation of a customer contact by the originator 204, who is typically a salesperson, in the form of a VOC submission. The first phase 210 commences in step 220, with the customer 202 making contact with the originator 204. In step 222, the originator 204 determines whether a response is required. If so, then in step 224, it is determined whether obtaining a response will require more than 24 hours. According to an aspect of the invention, a VOC submission is made only if a response will require more than 24 hours.

Thus, if it is determined in step 224 that less than 24 hours will be required to prepare a response, the originator 204 does not make a VOC submission. The originator 204 takes whatever steps are necessary to provide an immediate answer to the customer 202, including contacting personnel within the business organization and accessing business organization resources, as necessary.

If it is determined in step 224 that more than 24 hours is required to prepare a response, then in step 228, the originator 204 logs into the VOC system. As described below, according to an aspect of the invention, the VOC system is implemented on a website that is accessible over a network connection. In step 230, the originator 204 completes a VOC submission form that includes a description of the information communicated by the customer 202 and an identification of the business issue raised by the customer communication. Once the VOC submission form has been completed, the VOC submission is assigned a reference number and stored in a VOC database.

Returning to step 222, if it is determined that the customer communication does not require a response, then in step 232, the originator 204 determines whether the information communicated from the customer 202 is valuable. If the information is determined not to be valuable, then in step 234 the process is terminated. If the information is determined to be valuable, then the process goes to step 228, so that the information can be entered into the VOC system as an FYI submission.

The next phase 212 is the determination of ownership of the VOC submission. This phase 212 takes place after the information has been entered into the VOC system 206 and stored in the VOC database.

According to an aspect of the invention, the VOC submission form completed by the originator includes a section in which the originator identifies a business issue that the customer communication relates to. In step 240, the VOC system 206 uses the business issue selected by the originator and customer information contained in the VOC submission form to assign a VOC owner to the submission. In step 242, the VOC system 206 automatically notifies the VOC owner 208 by e-mail of the assignment, and provides the VOC owner with the VOC submission reference number with a direct link to the VOC submission stored in the database. In step 244, the VOC owner 200 accesses the VOC submission through the VOC website. In step 246, the VOC owner determines whether he or she is the correct owner of the submission. If not, the VOC owner updates the VOC submission by changing the business issues selected, and sends the process back to step 240. If in step 246 it is determined that the currently assigned VOC owner is in fact the correct owner, then the system proceeds to the next phase 214, in which the VOC owner develops a response to the VOC submission.

The response development phase 214 starts with the VOC owner determining in step 248 whether a response is required. If it is determined that no response is required, then in step 250 the VOC system 206 handles the submission as an FYI submission. If, however, it is determined that a response is required, then in step 252 the VOC owner develops a response to the submission. In step 254, the VOC database is updated to reflect the developed response. In step 256, the VOC owner determines whether the response is to be sent to the salesperson 204 for review, or is to be sent directly to the customer, with a copy of the response being sent to the originator in step 258. The VOC process 200 then enters its final phase 216, in which the developed response is provided to the salesperson 204 or to the customer 202.

If in step 256 it is determined that the response is to be first provided to the originator 204, then in step 260, the originator 204 is given the opportunity to review and modify the response. In step 262, the originator 204 then provides the response to the customer 202. In step 264, the customer is given the opportunity to review and comment on the response. Finally, in step 266, the VOC database is updated to reflect the customer's comments. If it is determined in step 256 that the response is not to be provided to the originator, then in step 258 a copy is provided to the originator 204, and the process proceeds directly to step 264, bypassing steps 260 and 262.

As mentioned above, according to an aspect of the invention, the VOC system is implemented on a website administered by a central server computer. Salespeople, VOC owners, and other authorized persons gain access to the VOC system by using a terminal connected to the central server computer to log onto the VOC website. The website includes a number of web pages that are designed to perform various functions of the VOC system, including making and updating VOC submissions. As further mentioned above, customers may also gain access to the VOC system through the VOC website to submit inquiries directly into the VOC system. Customer access to the website is limited to portions of the website that have been designated to be open to the public. Access to the remainder of the website is restricted to authorized persons within the business organization.

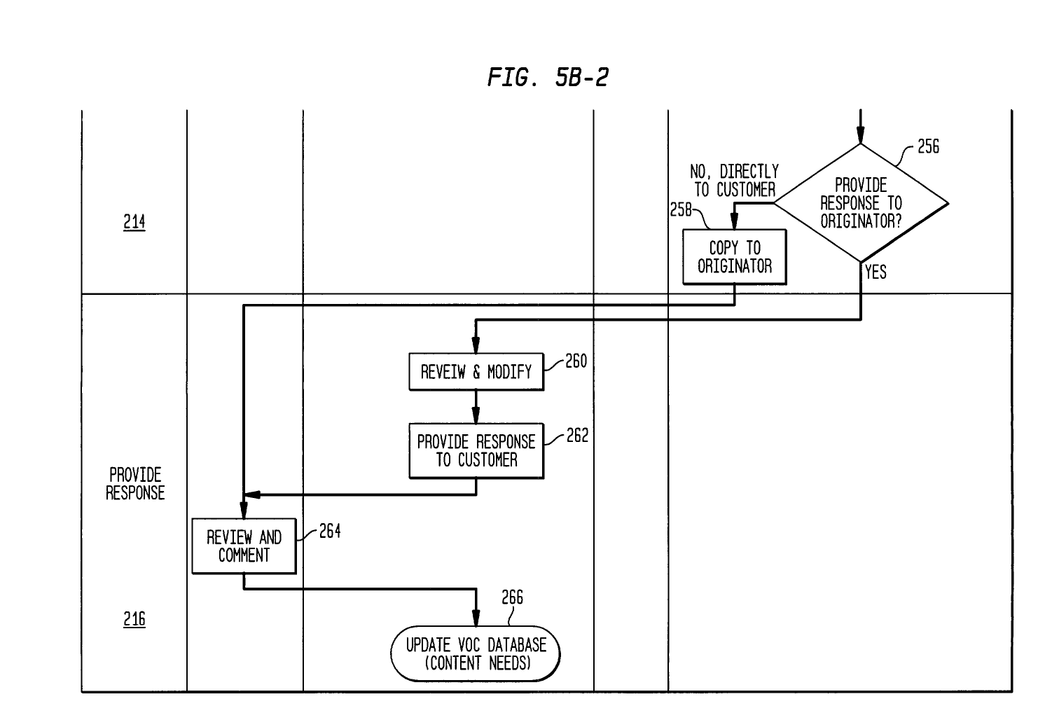

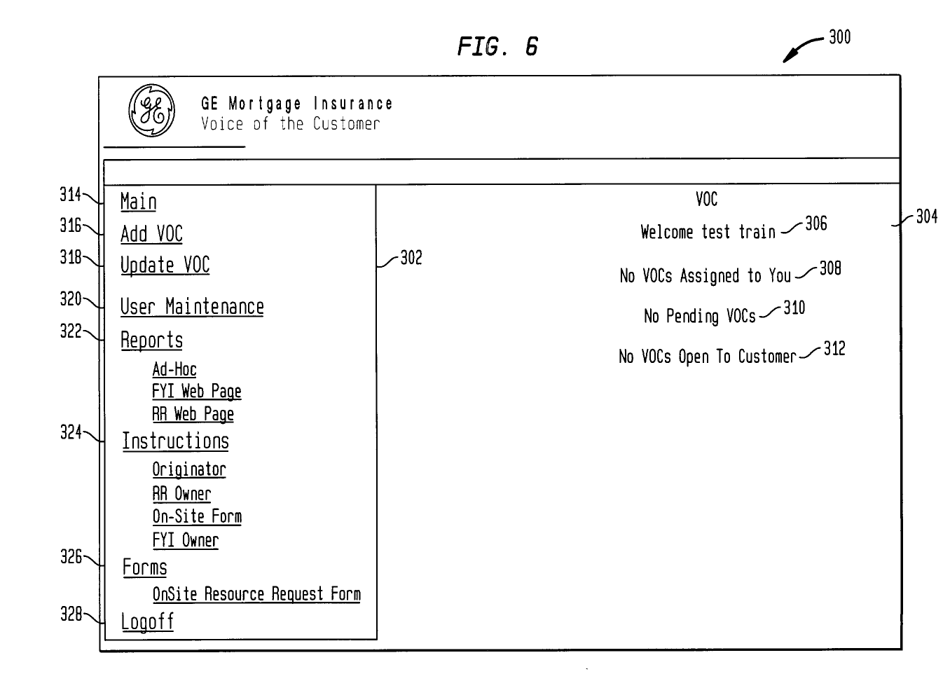

FIGS. 6-15 show screenshots of an exemplary set of web pages according to various aspects of the invention. A VOC originator, VOC owner, or other authorized user gains access to the VOC website by logging onto the website using an assigned user identifier (ID). Once the user has successfully logged into the system and has been identified to the system, the user's identification information is used to determine the user's website access rights, and to generate customized messages to the user.

FIG. 6 shows a screenshot of a main menu page 300 according to an aspect of the invention. The main menu page 300 includes a menu block 302 and a message block 304. The menu block 302 provides a list of menu selections, which transfer the user of the system to other web pages, as described below. The message block 304 displays messages that are customized to the user of the system. These customized communications including the following:

a welcome message 306, welcoming the user to the system;

a VOC assignment list 308, listing all VOC submissions that have been assigned to the user (this list is primarily for VOC owners using the system);

a pending VOC submission list 310, listing all VOC submissions that are currently waiting for a response from a VOC owner; and

an open to customer list 312, listing all VOC submissions in which an owner has provided an answer and the originator has to give the answer to the customer.

The menu block 302, includes the following menu selections, which provide links to other screens on the website:

Main 314. This menu selection returns the user to a main website page listing the work queues.

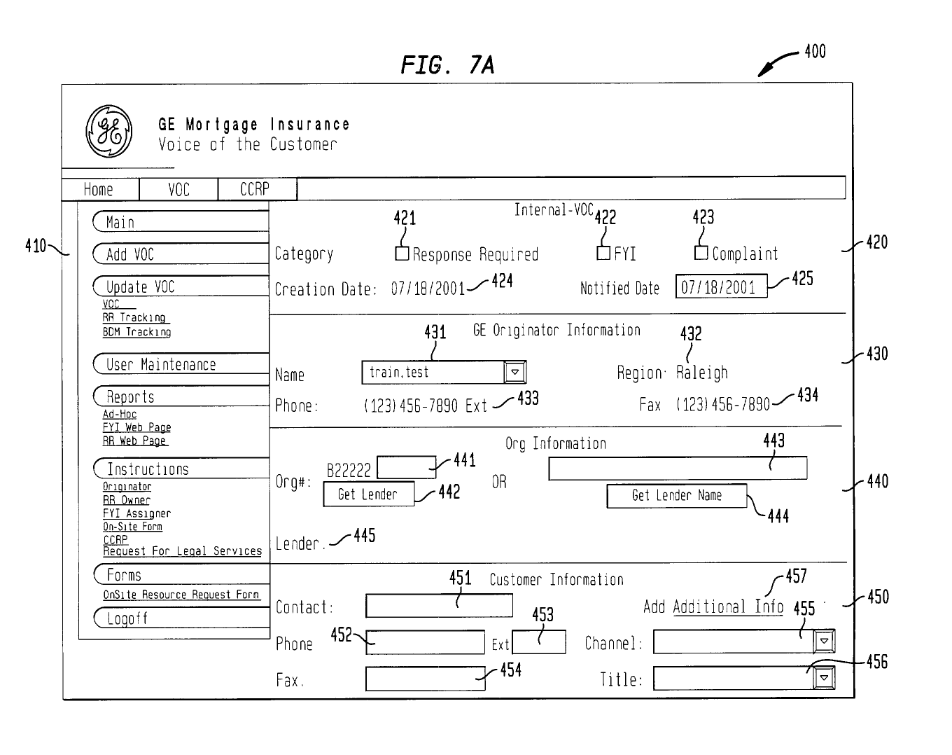

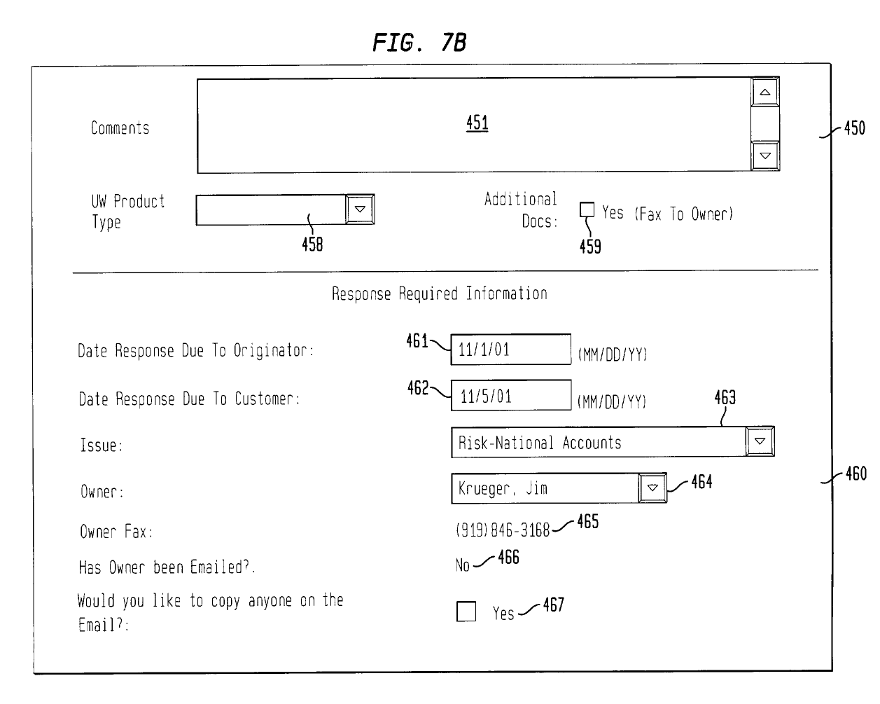

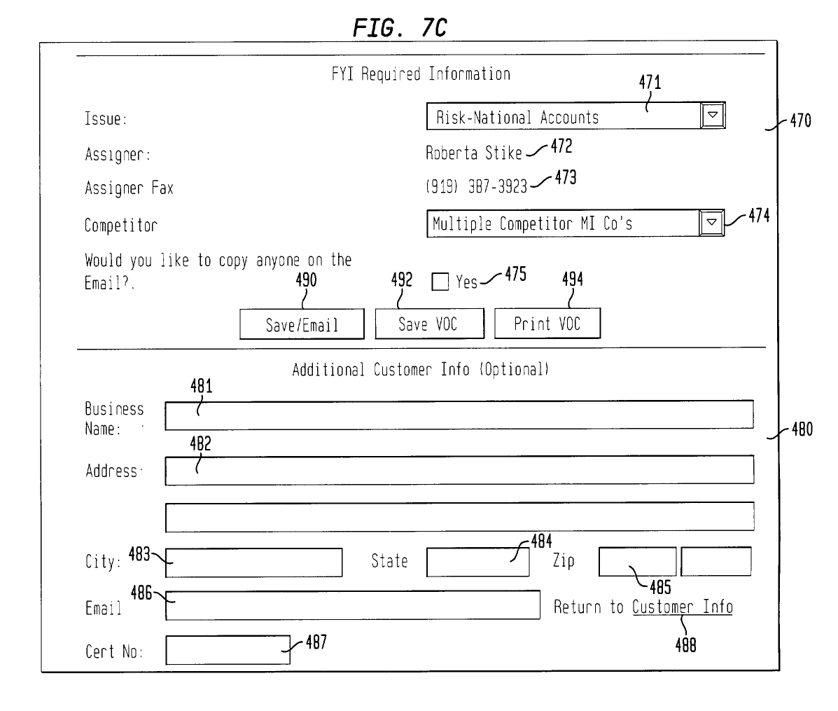

Add VOC 316. This menu selection provides a link to an add submission screen 400, shown in FIGS. 7A-C, and described below. The add submission screen is used by a salesperson or other VOC originator to make a VOC submission.

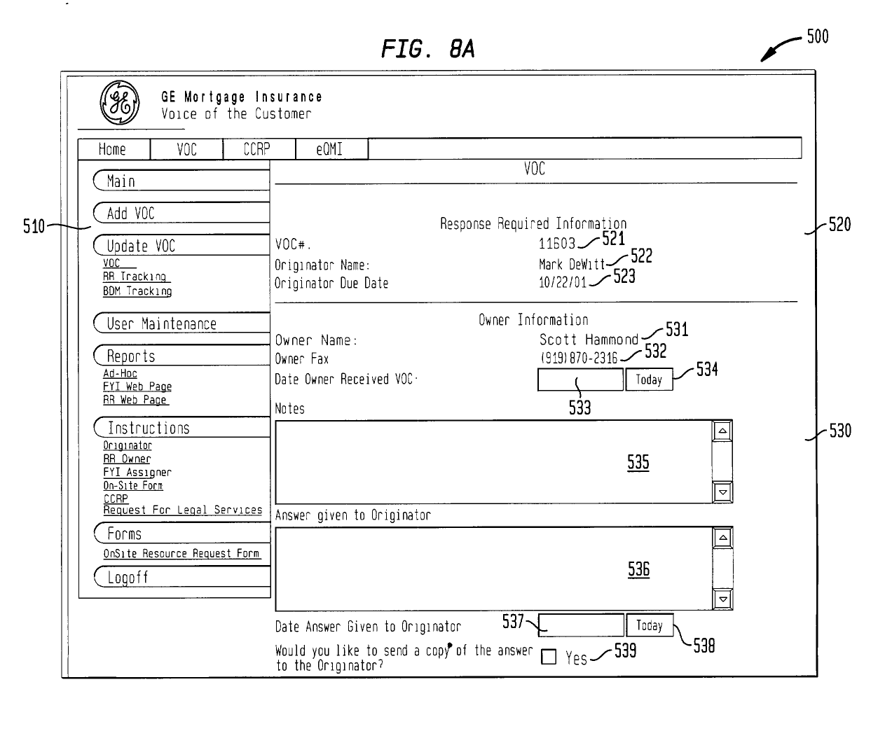

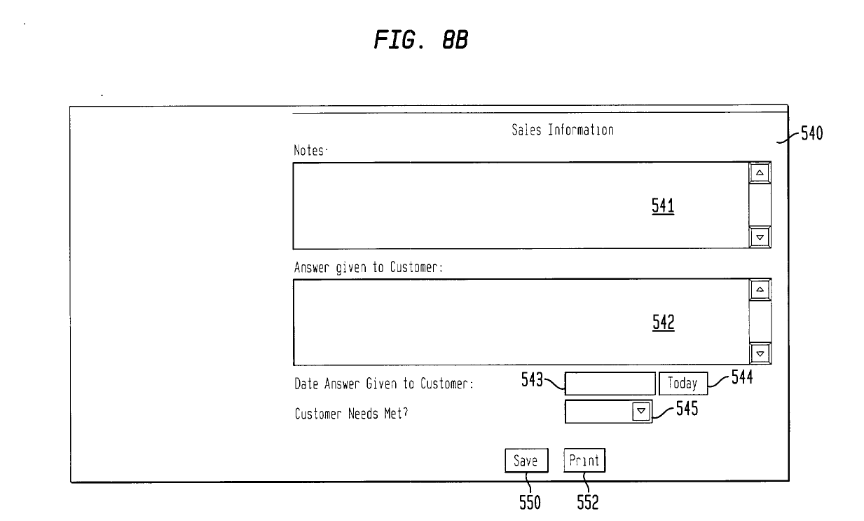

Update VOC 318. This menu selection provides a link to an update submission screen 500, shown in FIGS. 8A and 8B, and described below. The update submission screen is used by an assigned VOC owner, or other authorized person, to update a VOC submission that has been stored in the VOC database. For example, where a VOC owner has completed a response to a VOC submission, information relating to the response to the VOC submission is entered into the VOC system using the update submission screen.

User Maintenance 320. This menu selection allows user to update their contact information and functions.

Reports 322. These menu selections provide links to screens for generating reports relating to the VOC system or to search for data. These reports are used to monitor the execution of the VOC system.

Instructions 324. These menu selections provide links to screens that provide instructions to salespeople, VOC owners, and other users of the VOC system.

Forms 326. This menu selection provides a link to an on-site resource request form.

Logoff 328. This menus selection allows the user to log out of the VOC system.

FIGS. 7A-C show an add submission screen 400 according to an aspect of the invention. The add submission screen 400 is used by a salesperson or other VOC originator to make an initial VOC submission into the VOC system. As shown in FIG. 7, the add submission screen 400 includes the following sections: menu block 410; category block 420; originator information block 430; customer organization information block 440; customer information block 450; response required information block 460; FYI required information block 470; additional customer information block 480; and command buttons 490, 492, 494.

The menu block 410 is used to navigate among the various web pages at the website. Similar menu blocks are provided on other web pages, as described below.

The category block 420 includes three labeled checkboxes that are used to categorize the VOC submission: response required 421, FYI 422, and complaint 423. Clicking on the response required checkbox 421 causes the system to display the response required information block 460, discussed below. Clicking on the FYI checkbox 422 causes the system to display the FYI required information block 470, discussed below. Clicking on the customer complaint checkbox 423 channels the user into the business organization's customer complaint resolution process (CCRP). A customer complaint is treated by the VOC system as a response-required submission. Thus, clicking on the customer complaint checkbox 423 causes the system to display the response required information block 460.

In addition, the category block 420 displays the current date as a non-editable data field 424, which is stored with the VOC submission as its creation date. A date entry block 425 is provided for entering the date upon which the VOC originator was notified of the information that is the subject of the submission.

The originator information block 430 is used to identify the person making the VOC submission. This block 430 includes a dropdown list 431 including the names of all persons authorized to make a VOC submission. The default entry for the block 430 is the person logged into the VOC system. Selecting a name on the dropdown list causes the system to display the originator's region 432, telephone number 433, and fax number 434 as non-editable data fields. These items 432-434 are updated by using the User Maintenance feature, discussed above.

The customer organization information block 440 is used to identify the customer. Data entry boxes are provided for the organization number 441 or the lender name 443. Once either an organization number or lender name has been entered, the Get Lender button 442 or the Get Lender Name button 444 is depressed to update the VOC information and to provide a name in the Lender field 445.

The customer information block 450 is used to enter other customer information. Data boxes are provided for entering a contact person 451, telephone number 452, extension 453, fax number 454, channel 455, and title 456. The channel and title boxes 455 and 456 are filled using dropdown lists. If the user wishes to enter additional information, the user clicks on the Add Additional Information link 457.

If the user clicks on the Add Additional Information link 457, the user is shown the Additional Customer Information block 480 at the bottom of the add submission screen 400, in FIG. 7C. This block 480 can be used to enter additional customer information including: business name 481, address 482, city 483, state 484, zip 485, e-mail address 486 and certificate number 487. The user returns to the customer information block 450 by clicking on the Return to Customer Info link 488.

As shown in FIG. 7B, the customer information block 450 further includes a comment section 457, which is used to describe the information being submitted. A dropdown list 458 is provided to identifying the type of underwriting product to which the submission relates. A checkbox 459 is used to alert the VOC owner or other person reviewing the submission that additional documents are being submitted in connection with the VOC submission. These additional documents may be faxed to the VOC owner.

The response required information block 460 is displayed only if the response required checkbox 401 is selected in the category block 420. This block 460 contains the following data entry boxes to be filled in by the user: date response due to originator 461, date response due to customer 462, issue 463, owner 464, and owner fax 465. The issue and owner boxes are filled using dropdown lists. The response required information block 460 further displays a data field indicating whether the submission has been e-mailed to the VOC owner. Also, a checkbox 467 is provided indicating whether the user would like to copy anyone on the e-mail sent to the VOC owner.

The FYI required information block 470 shown in FIG. 7C is displayed only if the FYI checkbox 402 is selected in the category block 420. This block 470 includes a data entry box 471 for identifying the business issue, which is selected from a dropdown list. When a business issue has been selected, the system displays an assigner and the assigner's fax number in data fields 472 and 473. A data entry box 474 is provided for entering competitor information, which is selected from a dropdown list. The user is given the option of copying other persons on the e-mail by clicking on checkbox 475. Clicking on checkbox 475 will open another screen where other e-mail recipients can be selected.

After the add submission screen 400 has been filled in, the user then selects among the command buttons shown in FIG. 7C: Save/E-mail 490, Save VOC 492, and Print VOC 494. Clicking on the Save/E-mail button 490 causes the VOC submission to be stored in the VOC database, and to be e-mailed to the VOC owner designated in the response required information block 460 or the assigner designated in the FYI required information block 470. Clicking on the Save VOC button 492 causes the VOC submission to be stored in the database without e-mailing it to anyone else. Clicking on the Print VOC button 494 causes a hard copy of the submission to be printed.

Once the VOC submission has been stored in the VOC database, it is available for review and updating. If a response required submission has been entered into the VOC system, the assigned VOC owner receives the VOC submission by e-mail and then commences the development of a response, as described above. When the response has been completed, the VOC owner updates the VOC submission to document the response.

FIGS. 8A and 8B show an update submission screen 500 according to an aspect of the invention, which is used to track and update a response required (RR) submission. The update submission screen 500 includes the following sections: a menu block 510, a response required information block 520, a VOC owner information block 530, and a sales information block 540.

The menu block 510 is used to navigate among web pages. The required response information block contains information identifying the VOC submission being updated, including the VOC reference number 521, the name of the VOC originator 522, and the due date set by the VOC originator 523. The VOC owner information block 530 is used to document a response that has been developed by the VOC owner. The VOC information block 530 includes fields displaying the VOC owner's name 531 and fax number 532. In addition, a data entry box 533 is provided to allow the VOC owner to input the date the VOC submission was received. A Today button 534 is provided that automatically enters the current date into the date entry box 533.

The VOC information block 530 further includes a Notes block 535 in which the VOC owner may enter notes to be stored with the updated VOC submission, and an Answer block 536 in which the VOC owner enters a description of the response that has been developed. In addition, a date entry box 537 is provided for the VOC owner to enter the date the answer was given to the originator. A Today button 538 is provided that automatically enters the current date into the data entry box 537. In addition, the VOC owner is given the option of having a copy of the response sent to the originator by clicking on checkbox 539.

The update submission screen 500 further includes a sales information block 540, which is used to document a response to a VOC submission that has been entered into the system directly by a customer. The sales information block 540 includes a Notes block 541, in which the updater inputs notes to be stored as part of the updated VOC submission, and an Answer block 542, in which the updater inputs a description to the answer that has been given to the customer. In addition, a date entry box 543 is provided for the updater to enter the date the answer was given to the customer. A Today button 544 is provided that automatically enters the current date into the data entry box 543. Finally, the updater indicates by indicating in a data entry box 545 whether the customer needs have been met. This box 545 is filled in using a dropdown list.

After the update VOC form 500 has been completed, the updater must click on the Save button 550 to save the updated submission in the VOC database. The Print button 552 can be used to print a hard copy of the updated VOC submission.

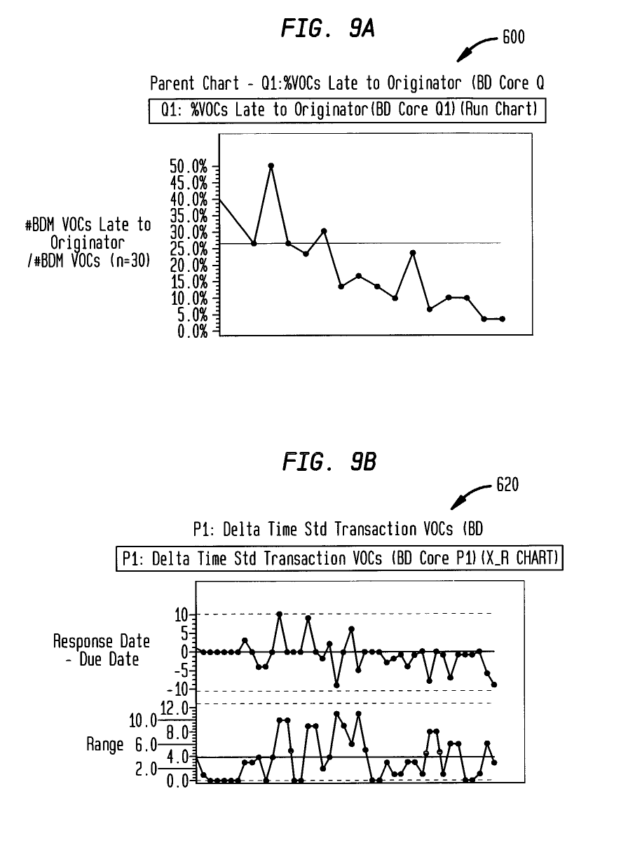

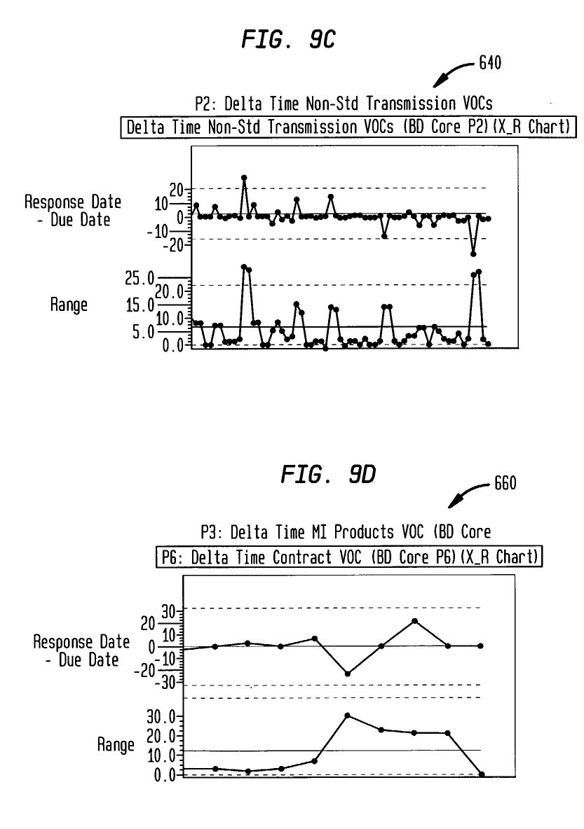

As mentioned above, an aspect of the VOC system is directed to the monitoring of the performance of a business organization in developing and providing responses to customer requests. Certain data generated by the VOC system can be integrated into a business organization's quality management systems. FIGS. 9A-D show four exemplary charts of VOC data that can be used to monitor response time. FIG. 9A shows a chart 600 that graphically represents the percentage of VOC responses that are made past their due dates. FIG. 9B shows a chart 620 that graphically represents the amount of time required to respond in a standard transaction. FIG. 9C shows a chart 640 that graphically represents the amount of time required to respond in a non-standard transaction. FIG. 9D shows a chart 660 that graphically represents the amount of time required to respond in VOC submissions related to mortgage insurance products.

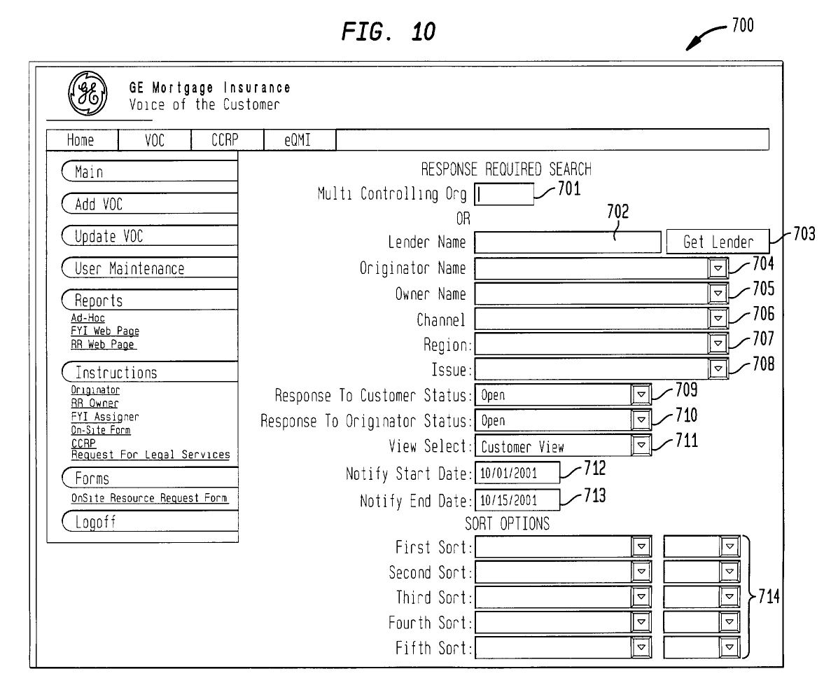

FIG. 10 shows a screenshot of a response required search screen 700 that is used to search for RR submissions meeting certain designated criteria. For example, RR submissions can be searched for by a multi-controlling organization number 701. Alternatively, RR submissions can be searched by filling in some or all of the following data entry boxes: lender name 702, originator name 704, owner name 705, channel 706, region 707, issue 708, response to customer status 709, and response to originator status 710. A Get Lender button 703 is provided to assist in filling in the lender name in data entry box 702.

In addition, the RR submission search screen 700 allows the user to select a desired view 711, and to narrow the search by the notify start date 712 and notify end date 713. In addition, the screen 700 provides a set of sort options 714, which allow the user to sort the retrieved submissions according to selected criteria in ascending or descending order.

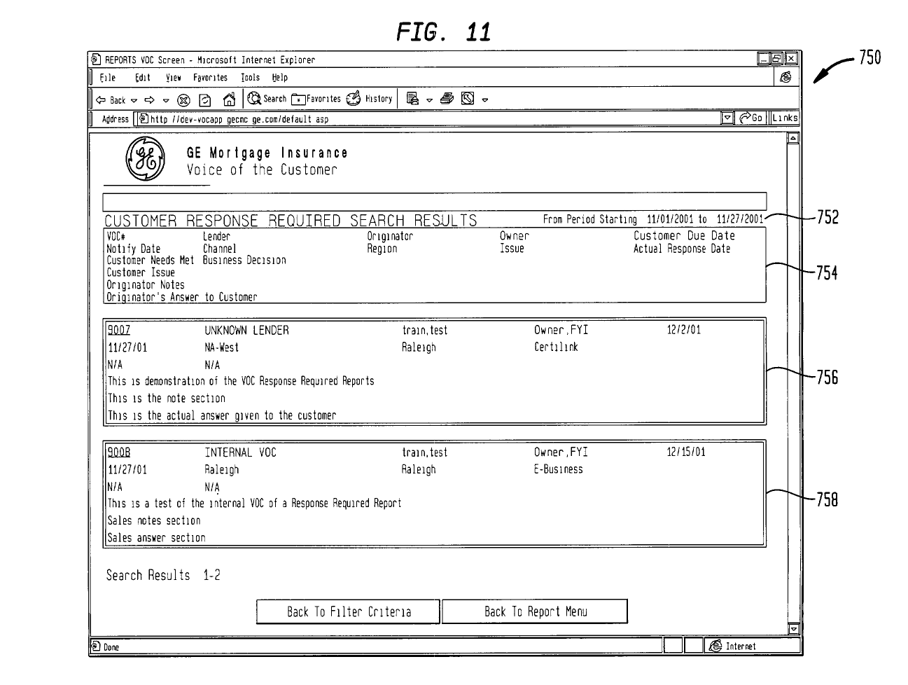

FIG. 11 shows a screenshot of a response required search results screen 750 that sets forth the results of an RR submission search. A field 752 is provided to display the search period. The top block 754 shows the data fields contained in each search result. Each block 756 and 758 under the top block 754 contains a separate RR submission.

FIG. 11 illustrates how the VOC system links together in a useful form pieces of information relating to a customer communication. As shown in block 754, each VOC submission links together under a VOC reference number: the notify date, the lender name and channel, the originator name and region, the owner and business issue, the customer due date and actual response date, the customer issue, originator notes, and the originator's answer to the customer.

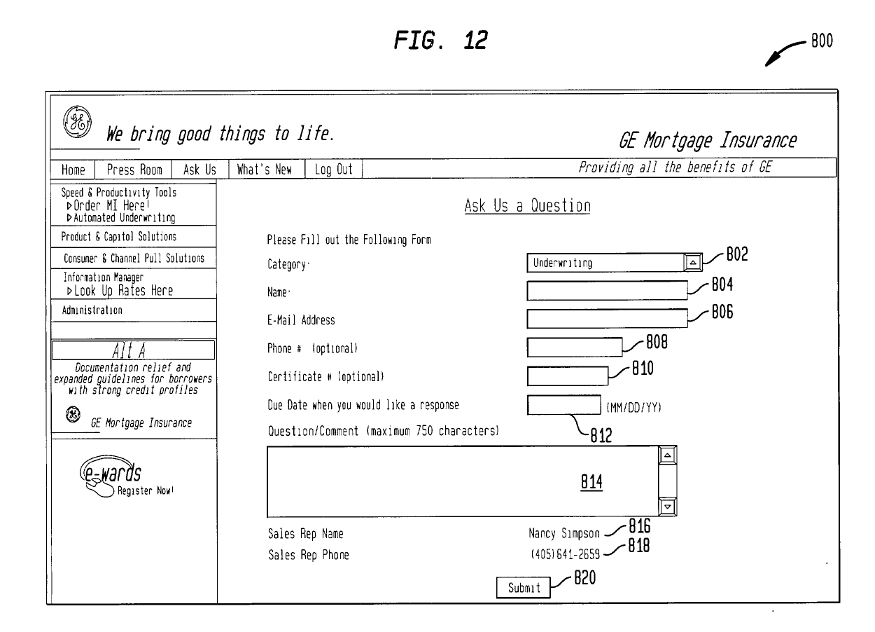

FIG. 12 shows a screenshot of an external customer submission form 800 according to an aspect of the invention. This form 800 is used by a customer to make a direct submission into the VOC system, in this case, by asking a question. Similar forms are provided for allowing a customer to make a direct submission of an FYI item or a complaint.

A customer accesses the form 800 by using an external connection to log in at www.gemortgageinsurance.com. The customer fills in a number of data entry boxes, including the following: category 802, name 804, e-mail address 806, phone number 808, certificate number 810, due date for a response 812, and the question or comment being submitted 814. The category box 802 is filled in by making a selection on a dropdown list. The customer's sales rep name and phone are displayed in non-editable data fields 816 and 818. After the form has been completed, the customer clicks on the Submit button 820 at the bottom of the screen.

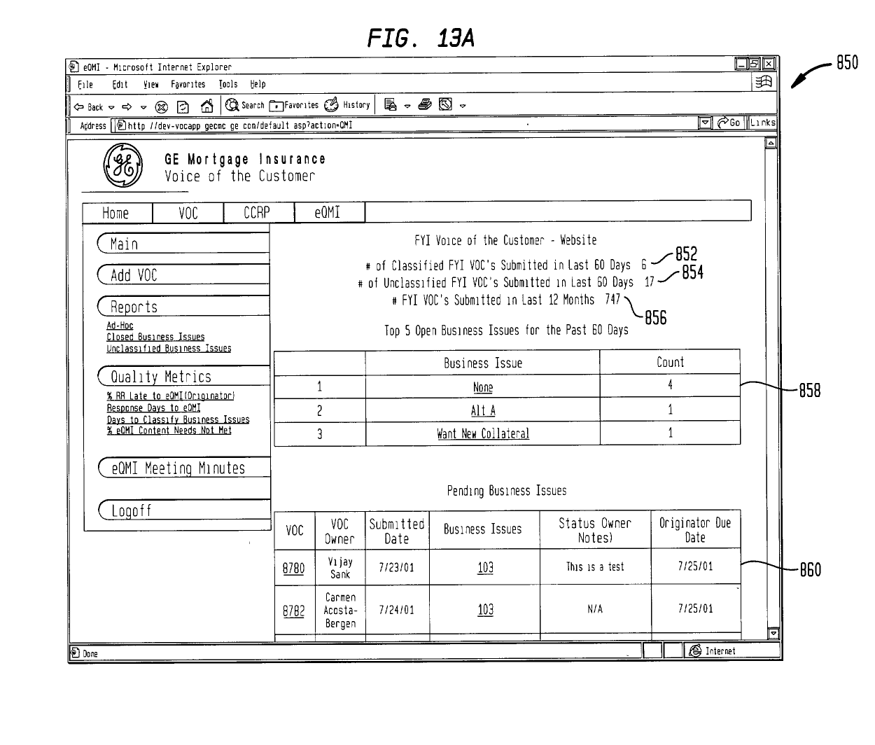

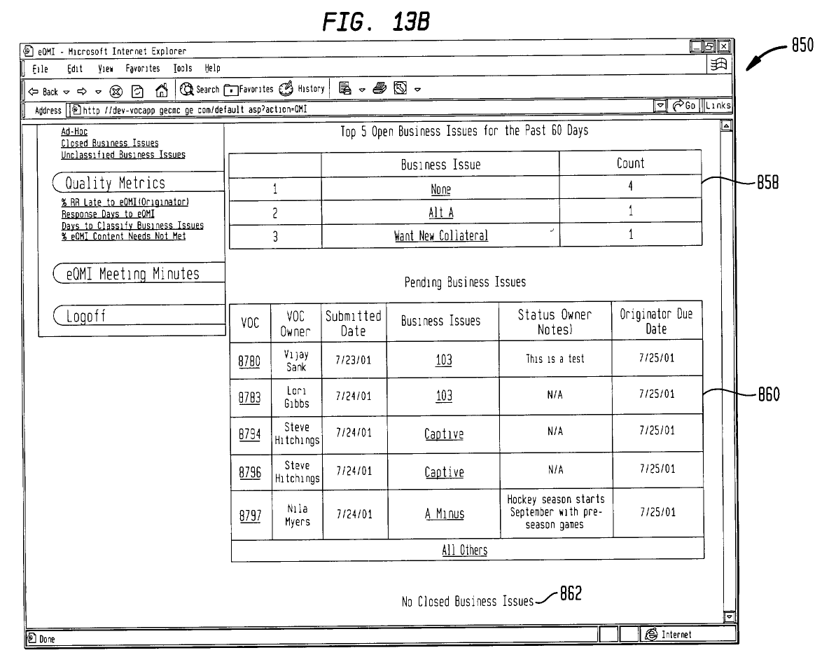

FIGS. 13A and 13B show an FYI response quality monitoring screen 850. The screen summarizes FYI submission activity by the following criteria: number of classified FYI VOC's submitted in the last 60 days 852, the number of unclassified FYI VOC's submitted in the last 60 days 854, and the number of FYI VOC's submitted in the last 12 months 856.

The FYI response quality monitoring screen 850 further includes a table 858 listing the top five open business issues for the past 60 days. The table 858 sets forth the count for each of these business issues, and provides a link to a separate web page for each issue. In addition, the screen 850 includes a table 860 setting forth pending business issues. Links are provided to each listed VOC submission by reference number, and to each business issue. A section is also provided for closed business issues 862. If there were any closed business issues, a table would appear at this portion of the screen 850. Where, however, there are no closed business issues, this information is set forth in a text field, as shown.

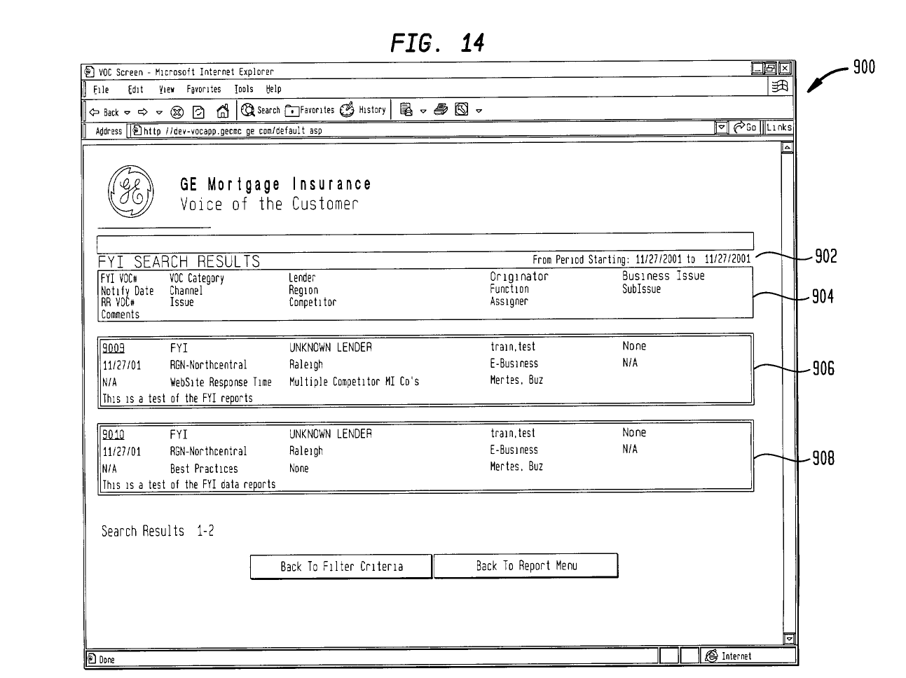

FIG. 14 shows an FYI search results screen 900, setting forth the results of an FYI submission search. The screen 900 includes a field 902 displaying the search period. The topmost block 904 contains a description of the data fields contained within each VOC submission retrieved. The remaining blocks 906 and 908 each contain a separate retrieved VOC submission.

FIG. 16 illustrates how the VOC system links together in a useful form various pieces of information under an FYI VOC reference number. As shown in block 902, these pieces of information include: VOC category, lender, originator, business issue, notify date, channel, region, function, sub-issue, RR VOC reference number, issue, competitor, assigner, and comments.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

We claim:

1. A system for managing a business organization's customer-related communications, comprising:
at least one originator terminal for receiving from an originator a submission containing a submission category, customer information, and an identified business issue;
a central server computer connected to the originator terminal for storing the submission in a database accessible by the central server computer, for assigning an owner to the submission based upon the submission category, customer information, and identified business issue, and for automatically notifying the owner of the assignment;
at least one owner terminal connected to the central server computer for providing access to the submission stored in the database, and for documenting a response to the submission by updating the submission.

2. The system of claim 1, wherein the system further includes:
at least one FYI assigner terminal connected to the central server computer for providing access to the submission stored in the database to an FYI assigner automatically designated by the central server computer based on the submission category, customer information, and identified business issue, and for documenting a response to the submission by updating the submission.

3. The system of claim 1, wherein the central server computer further includes:
a customer complaint resolution process software module run by the central server computer for handling a response to a submission containing a customer complaint.

4. The system of claim 1, wherein the system exports data to a quality management software module run by the central server computer for generating reports based upon submissions stored in the database.

5. The system of claim 1, further including a website administered by the central server computer for receiving a submission from an originator terminal, and for receiving a submission update from an owner terminal.

6. The system of claim 1, further including a customer terminal connected to the central server computer for receiving a submission directly from a customer.

7. A system for managing a business organization's customer-related communications, comprising:
a website administered by a central server computer;
at least one originator terminal connected to the central server computer;
at least one owner terminal connected to the central server computer; and
a database accessible by the central server computer,
the website including an add submission web page displayed at an originator terminal for receiving a submission containing customer-related information, the submission including a designated category selected from a set of categories including response-required submissions, FYI submissions, and customer complaint submissions,
the central server computer automatically storing the submission in the database,
the website further including an update submission web page that is displayed at an owner terminal for updating a submission stored in the central database to document a response to a submission.

8. The system of claim 7, further including a web page for searching submissions stored in the database and displaying search results.

9. The system of claim 7, further including an external customer submission web page that is displayed at an external customer terminal, the external customer submission web page being used by an external customer to make a submission directly into the system.

10. A method for managing a business organization's customer-related communications, comprising:
(a) using a central server computer to administer a network;
(b) receiving at an originator terminal connected into the network a submission containing customer-related information, the submission including a designation of a category of the submission, the designated category being selected from a set of categories including response required submissions, a response required submission including an assignment of the submission to an owner,
(c) transmitting a response-required submission to the central server computer;
(d) storing the response-required submission in a database accessible by the central server computer;
(e) automatically notifying the assigned owner of the response required submission;
(f) developing a response to the response-required submission;
(g) documenting the response to the response-required submission by using an owner terminal connected to the central server computer to access and update the response-required submission; and
(h) storing the updated response-required submission in the database.

11. The method of claim 10, wherein step (e) includes providing the owner with a workflow queue of requests to be worked on by the owner.

12. The method of claim 10, wherein the set of categories includes FYI submissions, an FYI submission including a designation of an assigner, and wherein the method further includes:
receiving an FYI submission at the originator terminal;
storing the FYI submission in the database;
automatically notifying the designated assigner of the FYI submission;
documenting a response to the FYI submission by using the owner terminal to access and update the FYI submission;
storing the updated FYI submission the database.

13. The method of claim 10, wherein the set of categories includes customer complaint submissions, and wherein the method further includes:
automatically invoking a customer complaint resolution process to handles the customer complaint.

14. The method of claim 10, further including:
generating quality management reports based upon submissions stored in the database.

15. The method of claim 10, wherein step (a) includes using the central server computer to administer a website, and wherein steps (b) and (g) include gaining access to the website.

16. The method of claim 10, further including:
receiving an external customer submission directly from an external customer terminal connected to the central server computer;
automatically storing the external customer submission in the database; and
notifying a VOC owner of the submission.

17. The method of claim 16, further including:
automatically sending a response to the customer by e-mail after the VOC owner has developed a response and entered it into the system.

18. A method for managing a business organization's customer-related communications, comprising:
(a) administering a website from a central server computer;
(b) displaying an add submission web page at an originator terminal connected to the center server computer;
(c) receiving at the add submission web page a submission containing customer-related information, the submission including a designated category selected from a set of categories including response-required submissions, FYI submissions, and customer complaint submissions,
(d) automatically storing the submission in the database,
(e) displaying an update submission web page at an owner terminal connected to the central server computer;
(f) documenting a response to a submission by using the update submission web page to access and update a submission stored in the database; and
(g) storing the updated submissions in the database.

18. The method of claim 17, further including:
displaying at a terminal connected to the central server computer a search submissions web page for search submissions stored in the database and displaying search results.

19. The method of claim 17, further including:
displaying an external customer submission web page at an external customer terminal connected to the central server computer;
using the external customer submission web page to receive a submission directly from a customer.
